(19) United States
(12) Patent Application Publication
(10) Pub. No.: US 2015/0188711 A1
(43) Pub. Date: Jul. 2, 2015

(54) METHODS AND SYSTEMS FOR VALIDATING E-SIGNED DOCUMENTS

(71) Applicant: Veri-Tax, LLC, Irvine, CA (US)

(72) Inventors: Maria Luisa Kirgan, Laguna Niguel, CA (US); Mauricio Aspiazo Cabrales, Barranquilla (CO); Rafael Mercado Mancilla, Barranquilla (CO)

(73) Assignee: Veri-Tax, LLC, Irvine, CA (US)

(21) Appl. No.: 14/144,326

(22) Filed: Dec. 30, 2013

(51) Int. Cl. H04L 9/32

(52) U.S. Cl. CPC H04L 9/3247

(57) ABSTRACT

A method of validating an electronically signed document may include receiving, by a computing device, an electronically signed document, receiving, by the computing device, an audit trail associated with the electronically signed document, determining an identity of a provider that submitted the electronically signed document and audit trail, determining, by the computing device, one or more applicable compliance rules associated with the electronically signed document and audit trail based on the identity of the provider, determining, by the computing device, one or more applicable keywords associated with the electronically signed document and audit trail based on the identity of the provider, and determining whether to validate the electronically signed document based on, at least in part, the applicable compliance rules and the applicable keywords.

### BACKGROUND

The use of electronic signatures or e-signatures has increased in popularity as a growing number of transactions now occur online. However, due to lack of industry standardization of e-signed documents and associated audit trails, it is often difficult to validate e-signed documents that are provided by different vendors.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a method of validating an electronically signed document may include receiving, by a computing device, an electronically signed document, receiving, by the computing device, an audit trail associated with the electronically signed document, determining an identity of a provider that submitted the electronically signed document and audit trail, determining, by the computing device, one or more applicable compliance rules associated with the electronically signed document and audit trail based on the identity of the provider, determining, by the computing device, one or more applicable keywords associated with the electronically signed document and audit trail based on the identity of the provider, and determining whether to validate the electronically signed document based on, at least in part, the applicable compliance rules and the applicable keywords.

In an embodiment, a system for validating an electronically signed document may include a computing device, and a computer-readable storage medium in communication with the computing device. The computer-readable storage medium may include one or more programming instructions that, when executed, cause the computing device to receive an electronically signed document, receive an audit trail associated with the electronically signed document, determine an identity of a provider that submitted the electronically signed document and audit trail, determine one or more applicable compliance rules associated with the electronically signed document and audit trail based on the identity of the provider, determine one or more applicable keywords associated with the electronically signed document and audit trail based on the identity of the provider, and determine whether to validate the electronically signed document based on, at least in part, the applicable compliance rules and the applicable keywords.

### BRIEF DESCRIPTION OF THE DRAWINGS

FIG. 1 illustrates an example system of validating an e-signed document according to an embodiment.

FIG. 2 illustrates an example method of validating an e-signed document according to an embodiment.

FIG. 3 illustrates an example audit trail according to an embodiment.

FIG. 4 illustrates an example tamper-evident seal according to an embodiment.

FIG. 5 illustrates an example user interface according to an embodiment.

FIG. 6 illustrates a block diagram of example hardware that may be used to contain or implement program instructions according to an embodiment.

### DETAILED DESCRIPTION

The following terms shall have, for purposes of this application, the respective meanings set forth below:

A “computing device” refers to a device that includes a processor and non-transitory, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like. When used in the claims, reference to “a computing device” may include a single device, or it may refer to several devices that together perform the claimed steps.

A “document” refers to an electronic record or file having content. Examples of documents may include, without limitation, tax documents such as IRS Forms 4506-T or 4506T-EZ, mortgage applications, loan documents and/or the like. According to various embodiments, a document may have any suitable format such as, for example, a word processing file, a spreadsheet file, a PDF, a slide presentations and/or the like.

An “electronic signature” refers to a way of signing an electronic message that identifies and authenticates a person as the source of the electronic message, and indicates the person's approval of the information contained in the electronic message.

An “e-signed document” refers to a document having an electronic signature.

An “e-signed submission” refers to an e-signed document and/or corresponding audit trail.

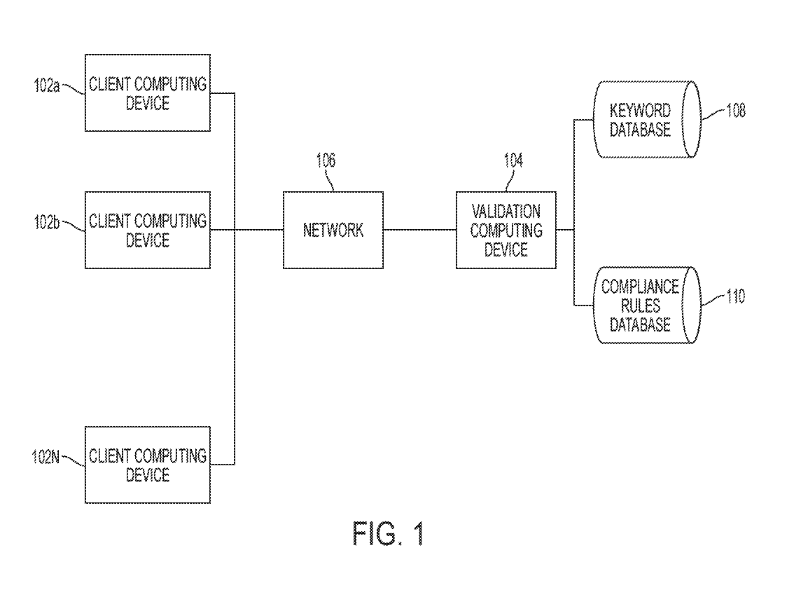

FIG. 1 illustrates an example system of validating an e-signed document according to an embodiment. As illustrated by FIG. 1, the system 100 may include one or more client computing devices 102a-N and a validation computing device 104 in communication with the one or more client computing devices 102a-N via a communication network 106. The validation computing device 104 may be in communication with a keyword database 108 and a compliance rules database 110.

A client computing device 102a-N may be a computing device associated with a provider who submits an e-signed document for validation. A provider may be an individual, a company, a vendor, an organization and/or the like. Examples providers may include, without limitation, banks, lenders and/or the like. Examples of client computing devices 102a-N may include, without limitation, a laptop computer, a desktop computer, a tablet, a mobile device and/or the like.

In an embodiment, a validation computing device 104 may be a computing device that is configured to validate one or more e-signed documents. A validation computing device 104 may be associated with a validation service. In an embodiment, a validation service may verify the authenticity of an e-signed document. Examples of a validation computing device 104 may include, without limitation, a server, a mainframe or other computing device. Although FIG. 1 illustrates a single validation computing device 104, it is understood that the system may include additional validation computing devices within the scope of this disclosure.

In an embodiment, the keyword database 108 and/or the compliance rules database 110 may be components of the validation computing device 104. As an alternative, the keyword database 108 and/or compliance rules database 110 may be separate from but in communication with the validation computing device. Although the keyword database 108 and compliance rules database 110 are referred to as databases in this disclosure, it is understood that other data structures, such as, for example, tables, lists and/or the like, may be used within the scope of this disclosure.

In an embodiment, a keyword database 108 may store one or more document keywords. One or more of the keywords may keyed to and specific to a provider. For example, a certain provider may require that a document and/or audit trail include certain keywords in order to be validated. The keyword database 108 may include, for one or more providers, the keyword or words that are specific to that provider.

A compliance rules database 110 may store one or more compliance rules associated with a document. Like keywords, compliance rules may be associated with a provider. For example, the compliance rules that one provider requires may be different from the compliance rules that another provider requires to validate its e-signed document.

In an embodiment, a communication network 106 may be a local area network (LAN), a wide area network (WAN), a mobile or cellular communication network, an extranet, an intranet, the Internet and/or the like. In an embodiment, a communication network 106 may provide communication capability between one or more client computing devices 102a-N and a validation computing device 104.

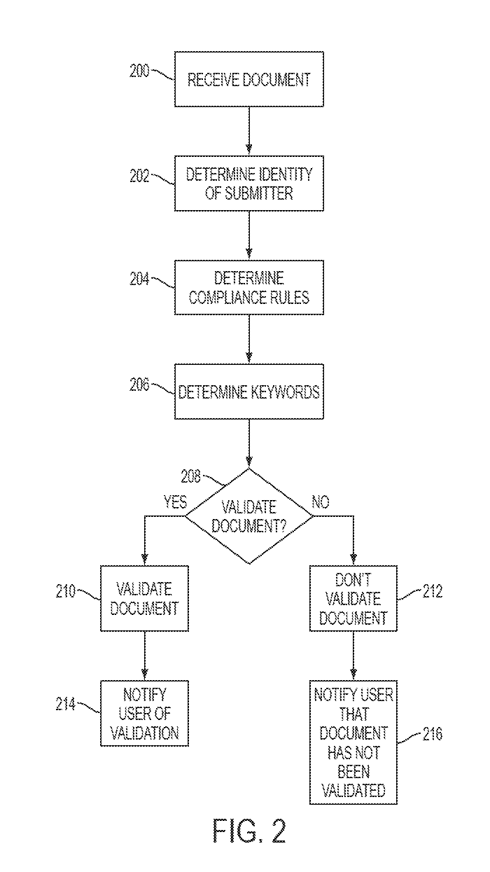

FIG. 2 illustrates an example method of validating an e-signed document according to an embodiment. In an embodiment, a provider may submit an e-signed submission to a validation system. As illustrated by FIG. 2, the system may receive 200 an e-signed submission. The system may receive 200 an e-signed submission from a provider computing device. For example, an e-sign provider may provide a bank with an e-signed document. The bank may send the e-signed document and/or corresponding audit trail to a validation service system to verify the authenticity of the e-signed document.

In an embodiment, an audit trail may be an electronic record or file that shows who has accessed the documents and what operations they have performed on the document over a certain time period. An audit trail may include one or more timestamps associated with one or more actions.

In an embodiment, as part of an e-signed submission, the system may receive 200 an e-signed document and an audit trail as separate files. In an alternate embodiment, an e-signed document and an audit trail may be the same file, with the audit trail being appended to the document. In an embodiment, an e-signed document and/or an audit trail may be a multi-page document. The received e-signed document and/or audit trail may be received as one compressed file, such as, for example, a zip file.

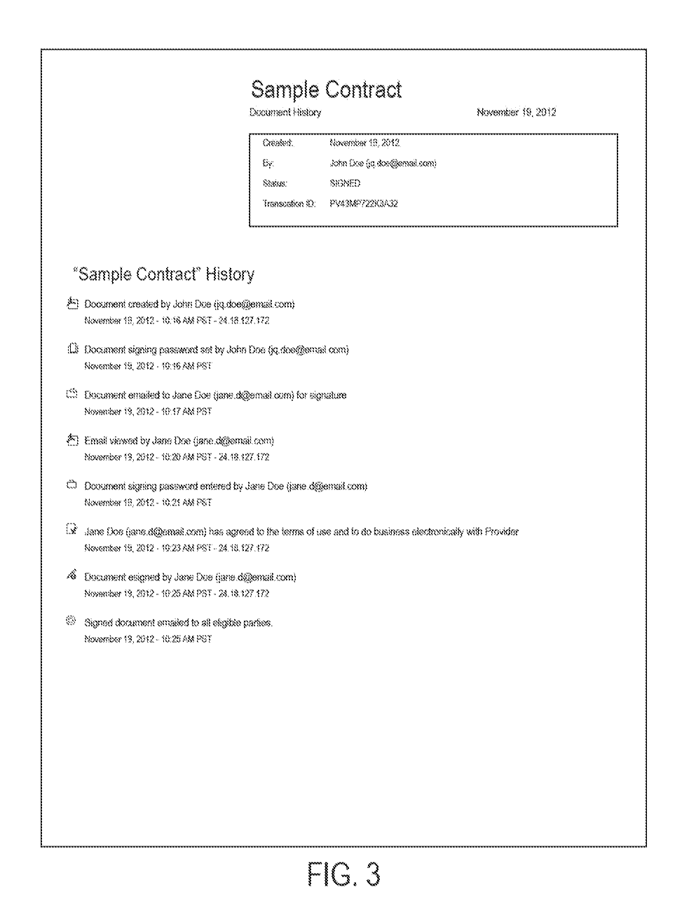

FIG. 3 illustrates an example audit trail according to an embodiment. An audit trail may include, for example, an indication of when the document was created, signed, emailed, and e-signed, among various other actions, along with the user who performed the actions and a timestamp associated with the actions. For instance, as illustrated by FIG. 3, the audit trail identifies that the document was created by John Doe on Nov. 19, 2012 at 10:16 am PST and was emailed to Jane Doe on Nov. 19, 2012 at 10:17 am PST. Jane Doe agreed to the terms of use on Nov. 19, 2012 at 10:23 am PST from IP address 24.18.127.172 and electronically signed the document on Nov. 19, 2012 at 10:25 am PST. The signed document was emailed to eligible parties on Nov. 19, 2012 at 10:25 am PST.

Referring back to FIG. 2, the system may determine 202 the identity of the provider submitting the e-signed submission. The system may determine 202 the identity of the submitting provider by analyzing the e-signed document and/or audit trail of the submission. For example, the system may perform a search of the contents of a received e-signed document and/or an audit trail to determine 202 the identity of a submitting provider.

In an embodiment, the system may determine 202 the identity of the submitting provider by analyzing at least a portion of the metadata associated with an e-signed document and/or audit trail of a submission. For example, metadata associated with an e-signed document and/or an audit trail may include an identifier associated with the submitting provider such as, for example, the name of the provider, a unique identifier associated with the provider and/or the like.

The system may determine whether a provider is an approved provider. An approved provider may be a provider that is allowed to submit e-signed documents to the system. The system may compare the identity of the determined provider with a list, a table, a database or other structure of approved providers. If the determined provider is identified as an approved provider, the system may continue to analyze the received submission. If the determined provider is not identified as an approved provider, the system may not continue analyzing the received submission. The system may notify the provider and/or a customer that the e-sign provider is not permitted to make a submission. The system may notify an operator, such as an administrator, that an unauthorized submission has been received.

In an embodiment, the system may determine 204 or more compliance rules. Compliance rules may include one or more actions that need to be performed on a document by one or more users in order for the document to be verified. For example, for an e-signature of a document to be verified, one or more actions may need to be performed on the document by one or more certain users. Compliance rules may specify that one or more actions be performed at certain times or within certain time periods. As an example, a compliance rule associated with a document and/or audit trail may be that a document signer must have consented to receiving and signing document electronically. As another example, a compliance rule associated with a document and/or audit trail may be that a signer has provided a valid signing password.

According to various embodiments, compliance rules may indicate an order of actions to be performed. For example, for a document of a certain provider to be validated, the document's audit trail may need to indicate that the signer has viewed the document, provided a valid signing password, agreed to the terms of use and to business electronically with the provider and e-signed the document, in that order. In an embodiment, the order in which certain actions are performed may be determined by a timestamp associated with one or more actions.

In an embodiment, the system may determine 204 one or more compliance rules based on the identity of the submitting provider. For example, the system may access a compliance rules database to determine one or more compliance rules for the provider.

In various embodiments, one or more compliance rules may indicate one or more characteristics of a document that are to be present for the document to be validated. As another example, a compliance rule may specify that an audit trail include an email address, an IP address and/or other information associated with a signer.

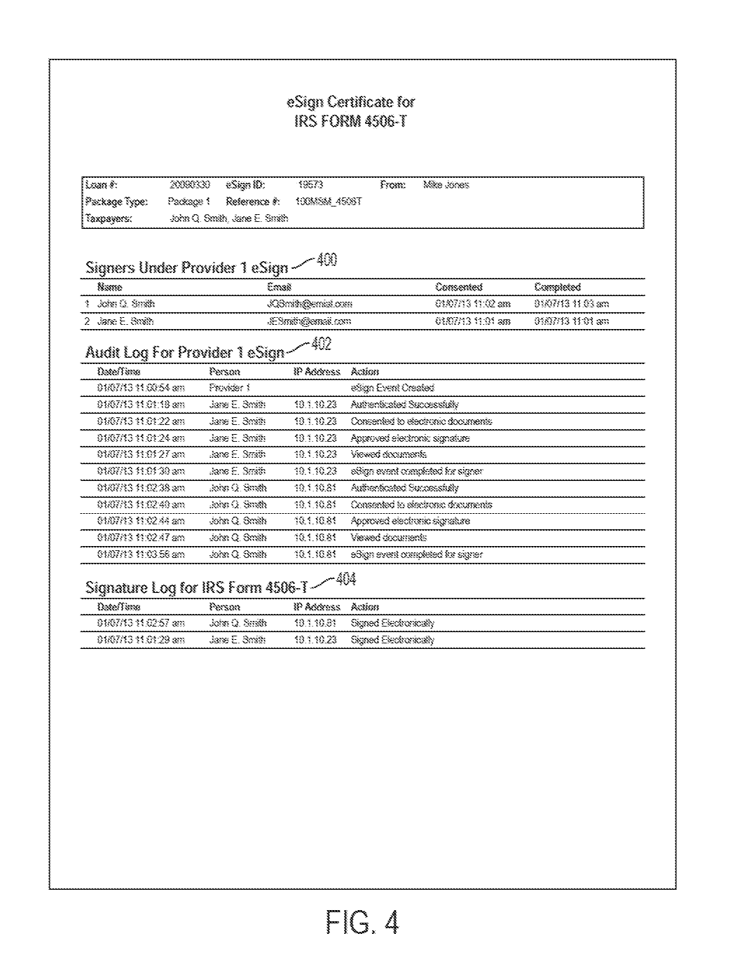

As another example, a compliance rule may specify that a submission be associated with a tamper-evident seal. A tamper-evident seal may be a digital certificate associated with a submission that makes unauthorized access to a submission detectable. In an embodiment, a seal may be a part of a submission. FIG. 4 illustrates an example tamper-evident seal according to an embodiment. As illustrated by FIG. 4, the tamper-evident seal may include an indication of the validity of the electronic signature(s) within the document.

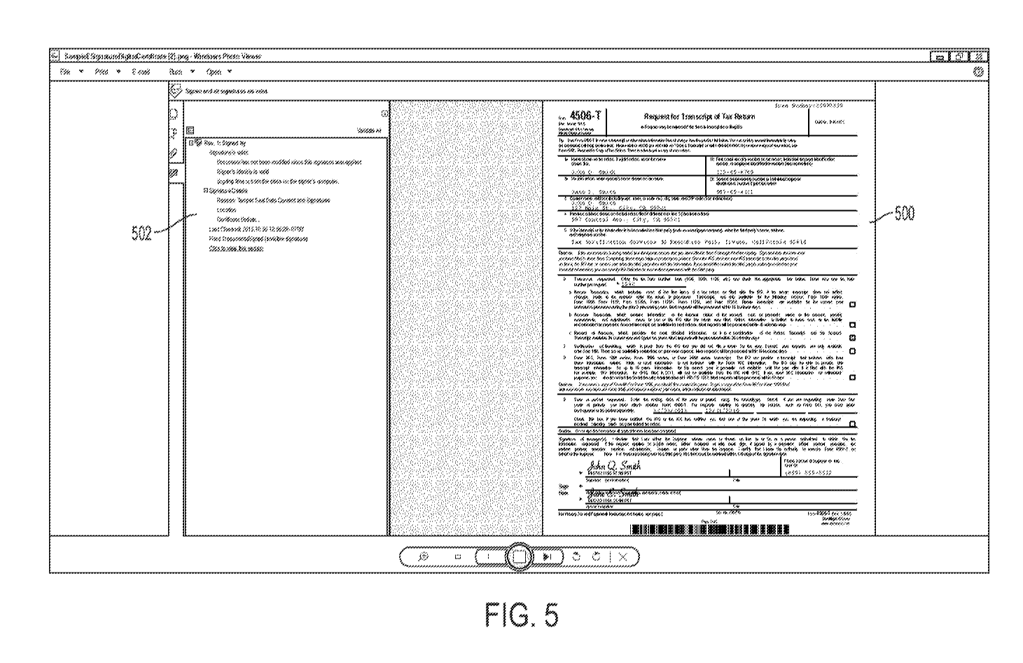

FIG. 5 illustrates an example user interface showing an e-signed document 500 and a signature panel 502. The signature panel 502 may include information indicating whether the document 500 has been tampered with and/or whether the tamper-evident seal has been broken. For example, referring to FIG. 5, the signature panel 502 indicates that the document has not been modified since the signature has been applied.

A compliance rule may indicate that one or more electronic files containing the document and/or corresponding audit trail are named according to a particular format. For example, a system may specify that an electronic file containing a document be named according to the following format: FormType_LoanNumber_Timestamp.pdf. Similarly, a system may specify that an electronic file containing an audit trail be named according to the following format: AuditTrail_LoanNumber_Timestamp.pdf. Additional and/or alternate names and/or formats may be used within the scope of this disclosure.

According to various embodiments, the system may determine 206 one or more keywords. Keywords may be words and/or phrases that must be present in an e-signed document and/or an audit trail in order for the e-signed document to be validated. Example keywords may include, without limitation, “authentication”, “consent” and/or the like. Table 1 illustrates example entries in a keyword database according to an embodiment.

TABLE 1

| Provider | Keywords (Consent) | Keywords (Audit Trail) |
|---|---|---|
| Provider 1 | has agreed to the terms of use | document history |
| | and to do business | |
| | electronically | |
| Provider 2 | consent | certificate of completion |
| Provider 3 | consented | esign certificate |
| Provider 4 | accepted | authentication |
| Provider 5 | consent | verified |
| Provider 6 | consented | authenticated |

As illustrated by Table 1, a provider may be associated with one or more keywords in one or more categories or portions of an e-signed submission. For instance, a provider may require that one or more keywords be present to indicate consent and that one or more keywords be present in an audit trail. For example, as illustrated in Table 1, Provider 4 requires that the word “accepted” be present to indicate consent and that the word “authentication” be present in the audit trail. Additional and/or alternate keywords, categories and portions of an e-signed document and/or audit trail may be used within the scope of this disclosure.

In an embodiment, the keywords that are determined 206 may depend on the identity of the submitting provider. For example, a certain provider may require that a document and/or audit trail include certain keywords in order to be validated. These keywords may be the same or different from the keywords associated with one or more other providers.

As illustrated by FIG. 2, the system may determine 208 whether to validate an e-signed submission. To determine 208 whether to validate the e-signed submission, the system may perform a validation process on the e-signed document and/or audit trail included in the submission. As part of the validation process, the system may determine whether the document and/or audit trail includes the determined keywords and/or satisfies one or more of the determined compliance rules. In an embodiment, if the document and/or audit trail includes each determined keyword and satisfies each determined compliance rule, the system may validate 210 the document. Otherwise, the system may not validate 212 the document. As illustrated by FIG. 4, the audit trail may include one or more indications of the signers 400, a least a portion of an audit log 402 and/or a least a portion of a signature log 404.

In an embodiment, if the system validates 208 a document, the system may notify 212 the submitting provider that the document has been validated. The system may store the document and/or corresponding audit trail. For instance, the system may store the document and/or corresponding audit trail for future requests such as, for example, audit requests by the Internal Revenue Service.

In an embodiment, if the system validates 208 a document, the system may make at least a portion of the document and/or audit trail available to a third party for processing. For example, if the document is a mortgage application, the system may transmit the document to a third party, such as the Internal Revenue Service, for further processing or may make the document accessible to the bank, such as, for example, via a download. As another example, the system may make the document available to an agency to perform an audit process. Additional and/or alternate third parties may be sent documents within the scope of this disclosure.

If the system does not validated 210 the document, the system may notify 214 the submitting party that the document has not been validated. The notification may include an explanation as to why the document has not been validated. For example, if the document and/or audit trail is missing one or more keywords and/or does not satisfy one or more compliance riles, the notification may indicate as such.

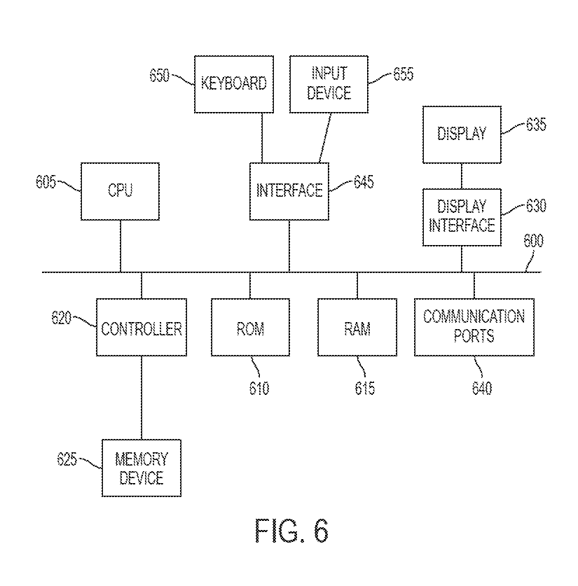

FIG. 6 depicts a block diagram of hardware that may be used to contain or implement program instructions. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 6, is an example of a production device, computing device or processor as such terms are used within this disclosure. Read only memory (ROM) 610 and random access memory (RAM) 615 constitute examples of non-transitory computer-readable storage media.

A controller 620 interfaces with one or more optional non-transitory computer-readable storage media 625 to the system bus 600. These storage media 625 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 610 and/or the RAM 615. Optionally, the program instructions may be stored on a tangible non-transitory computer-readable medium such as a compact disk, a digital disk, flash memory, a memory card, a USB drive, an optical disc storage medium, such as a Blu-ray™ disc, and/or other recording medium.

An optional display interface 630 may permit information from the bus 600 to be displayed on the display 635 in audio, visual, graphic or alphanumeric format. Communication with external devices, such as a printing device, may occur using various communication ports 640. A communication port 640 may be attached to a communications network, such as the Internet or an intranet.

The hardware may also include an interface 645 which allows for receipt of data from input devices such as a keyboard 650 or other input device 655 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A method of validating an electronically signed document, the method comprising:
receiving, by a computing device, an electronically signed document;
receiving, by the computing device, an audit trail associated with the electronically signed document;
determining an identity of a provider that submitted the electronically signed document and audit trail;
determining, by the computing device, one or more applicable compliance rules associated with the electronically signed document and audit trail based on the identity of the provider;
determining, by the computing device, one or more applicable keywords associated with the electronically signed document and audit trail based on the identity of the provider; and
determining whether to validate the electronically signed document based on, at least in part, the applicable compliance rules and the applicable keywords.

2. The method of claim 1, wherein determining one or more applicable compliance rules comprises identifying, from a compliance rule database, one or more compliance rules associated with the provider that the provider requires be satisfied for the electronically signed document to be validated.

3. The method of claim 1, wherein determining one or more applicable keywords comprises identifying, from a keyword database, one or more keywords associated with the provider that the provider requires be present in the electronically signed document or audit trail for the electronically signed document to be validated.

4. The method of claim 1, wherein determining whether to validate the electronically signed document comprises:
determining whether the electronically signed document satisfies each of the compliance rules; and
in response to determining that the electronically signed document satisfies each of the compliance rules, validating the electronically signed document.

5. The method of claim 1, wherein the one or more applicable compliance rules comprise one or more of the following requirements:
the electronically signed document be associated with a tamper-evident seal;
a title of an electronic file comprising the electronically signed document has a certain format; and
a title of an electronic file comprising the audit trail has a certain format.

6. The method of claim 1, wherein determining whether to validate the electronically signed document comprises:
determining whether the electronically signed document, the audit trail or both the electronically signed document and the audit trail comprise the keywords; and
in response to determining that the electronically signed document, the audit trail or both the electronically signed document and the audit trail comprise the keywords, validating the electronically signed document.

7. The method of claim 1, wherein determining whether to validate the electronically signed document comprises validating the electronically signed document in response to:
the electronically signed document satisfying each of the compliance rules;
the electronically signed document being associated with a tamper-evident seal;
a title of an electronic file comprising the electronically signed document having a certain format;
a title of an electronic file comprising the audit trail having a certain format; and
the electronically signed document, the audit trail or both the electronically signed document and the audit trail comprising the keywords.

8. The method of claim 1, further comprising, in response to determining to validate the electronically signed document, performing one or more of the following:
notifying the provider that the electronically signed document has been validated; and
storing the electronically signed document;
storing the audit trail; and
making the electronically signed document, the audit trail or both the electronically signed document and the audit trail available to a third party.

9. The method of claim 1, further comprising, in response to determining not to validate the electronically signed document, notifying the provider that the electronically signed document has not been validated.

10. A system for validating an electronically signed document, the system comprising:
a computing device; and
a computer-readable storage medium in communication with the computing device, wherein the computer-readable storage medium comprises one or more programming instructions that, when executed, cause the computing device to:
receive an electronically signed document,
receive an audit trail associated with the electronically signed document,
determine an identity of a provider that submitted the electronically signed document and audit trail,
determine one or more applicable compliance rules associated with the electronically signed document and audit trail based on the identity of the provider,
determine one or more applicable keywords associated with the electronically signed document and audit trail based on the identity of the provider, and
determine whether to validate the electronically signed document based on, at least in part, the applicable compliance rules and the applicable keywords.

11. The system of claim 10, wherein the one or more programming instructions that, when executed, cause the computing device to determine one or more applicable compliance rules comprise one or more programming instructions that, when executed, cause the computing device to identify, from a compliance rule database, one or more compliance rules associated with the provider that the provider requires be satisfied for the electronically signed document to be validated.

12. The system of claim 10, wherein the one or more programming instructions that, when executed, cause the computing device to determine one or more applicable keywords comprise one or more programming instructions that, when executed, cause the computing device to identify, from a keyword database, one or more keywords associated with the provider that the provider requires be present in the electronically signed document or audit trail for the electronically signed document to be validated.

13. The system of claim 10, wherein the one or more programming instructions that, when executed, cause the computing device to determine whether to validate the electronically signed document comprise one or more programming instructions that, when executed, cause the computing device to:
determine whether the electronically signed document satisfies each of the compliance rules; and
in response to determining that the electronically signed document satisfies each of the compliance rules, validate the electronically signed document.

14. The system of claim 10, wherein the one or more applicable compliance rules comprise one or more of the following requirements:
the electronically signed document be associated with a tamper-evident seal;
a title of an electronic file comprising the electronically signed document has a certain format; and
a title of an electronic file comprising the audit trail has a certain format.

15. The system of claim 10, wherein the one or more programming instructions that, when executed, cause the computing device to determine whether to validate the electronically signed document comprise one or more programming instructions that, when executed, cause the computing device to:
determine whether the electronically signed document, the audit trail or both the electronically signed document and the audit trail comprise the keywords; and
in response to determining that the electronically signed document, the audit trail or both the electronically signed document and the audit trail comprise the keywords, validate the electronically signed document.

16. The system of claim 10, wherein the one or more programming instructions that, when executed, cause the computing device to determine whether to validate the electronically signed document comprises one or more programming instructions that, when executed, cause the computing device to validate the electronically signed document in response to:
the electronically signed document satisfying each of the compliance rules;
the electronically signed document being associated with a tamper-evident seal;
a title of an electronic file comprising the electronically signed document having a certain format;
a title of an electronic file comprising the audit trail having a certain format; and
the electronically signed document, the audit trail or both the electronically signed document and the audit trail comprising the keywords.

17. The system of claim 10, wherein the computer-readable storage medium further comprises one or more programming instructions that, when executed, cause the computing device to, in response to determining to validate the electronically signed document, perform one or more of the following:
notifying the provider that the electronically signed document has been validated; and
storing the electronically signed document;
storing the audit trail; and
making the electronically signed document, the audit trail or both the electronically signed document and the audit trail available to a third party.

18. The system of claim 10, wherein the computer-readable storage medium further comprises one or more programming instructions that, when executed, cause the computing device to, in response to determining not to validate the electronically signed document, notify the provider that the electronically signed document has not been validated.
